(19) United States
(12) Patent Application Publication
(10) Pub. No.: US 2025/0229858 A1
(43) Pub. Date: Jul. 17, 2025

(54) BICYCLE RACK

(71) Applicant: Enosh CASSEL, Rye Brook, NY (US)

(72) Inventor: Enosh CASSEL, Rye Brook, NY (US)

(21) Appl. No.: 18/578,673

(22) PCT Filed: Jul. 14, 2022
(86) PCT No.: PCT/US2022/037084

§ 371 Date: Jan. 11, 2024

Related U.S. Application Data
(60) Provisional application No. 63/221,855, filed on Jul. 14, 2021.

(51) Int. Cl. B62H 3/12; B62H 3/02; F16M 13/02

(52) U.S. Cl. CPC B62H 3/12; B62H 3/02; F16M 13/022; F16M 2200/06

(57) ABSTRACT

A bicycle rack capable of storing and hanging a bicycle on the external side of a high rise balcony railing safely and efficiently is provided. The bicycle rack includes a coupler or clamp for securing the rack to a handrail of the high rise balcony. A rotatable arm assembly is configured to rotate about the clamp. The rotatable arm assembly is attached to a mounting assembly for securing the bicycle to the bicycle rack. The arm assembly enables the attached bicycle to rotate from an internal side of the railing to the external side of the railing.

### CROSS-REFERENCE TO RELATED APPLICATIONS

This application claims priority to U.S. Provisional Application Ser. No. 63/221,855 filed Jul. 14, 2021 which is hereby incorporated in its entirely at least by reference.

### BACKGROUND OF THE INVENTION

### 1. Field of the Invention

The present invention relates to a bicycle rack and more particularly to a rotatable bicycle rack configured to attach to an elevated railing, such as a high rise balcony railing, for improved space-saving and safety.

### 2. Description of Related Art

It is well known in the art that bicycle racks are used to attach a bicycle to one or more surfaces and structures, including vehicles, ceilings, walls, posts, or other storage locations when the bicycle is not in use. The bicycle storage locations for residents in high rise apartment buildings are limited. Often, bicycles are stored on a resident's balcony if there is no suitable location for mounting inside the building. Further, bicycles are bulky and take up significant usable space on the balcony floor. Similarly, in some apartments, large windows with railings are provided without a balcony floor and bicycles take up usable floor space in the apartment. Thus, sometimes bicycles are hung from the exterior railing of the balcony to free up the balcony floor. However, this is very dangerous as the bicycle may fall several stories below when attempting to lift the bicycle over the height of the railing. Consequently, a rotatable bicycle rack configured to attach to a railing for improved space-saving and safety is needed.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

It is an object of the present invention to provide a device capable of storing and hanging a bicycle on the external side of a high rise balcony safely and efficiently.

In order to do so, a bicycle rack is provided, comprising a clamp assembly having a clamp, the clamp configured to removably fasten the clamp assembly to a railing; an arm assembly rotatably attached to the clamp assembly; a mounting member configured to fasten and removably attach a bicycle to the bicycle rack, wherein the mounting member is rotatably connected to the arm assembly; and, the arm assembly enabling the attached bicycle to rotate from an internal side of the railing to an external side of the railing.

In one embodiment, the arm assembly comprises a lower arm and an upper arm configured to rotate independently. In one embodiment, the lower arm is attached to the clamp assembly via a first hinge, the lower arm is attached to the upper arm via a second hinge, and the upper arm is attached to mounting member via a third hinge. In another embodiment, at least one of the first hinge, the second hinge, and the third hinge includes a torsion spring. In one embodiment, the lower arm has approximately 180 degrees of rotation via the first hinge. In yet another embodiment, the clamp assembly further comprises a clamp plate, wherein the clamp plate includes mounting brackets for holding the first hinge and torsion spring. In one embodiment, the lower arm and the upper arm each comprise multiple arm members for stability. In another embodiment, a support member is provided, wherein the support member protrudes from the upper arm configured to support at least a portion of the bicycle during rotation. In one embodiment, the clamp is configured to removably fasten to a handrail of the railing. In one embodiment, the railing is a balcony railing. In another embodiment, the mounting member comprises a rectangular body forming a channel having retaining openings configured to retain one or more portions of the bicycle.

In another aspect of the invention, a method of storing a bicycle on an external side of a balcony railing is provided, comprising steps: (a) providing a bicycle rack comprising a clamp, an arm assembly rotatably attached to the clamp, and a mounting member; (b) attaching, via the clamp, the bicycle rack to a handrail of the balcony railing; (c) fastening, via the mounting member, the bicycle to the bicycle rack; and, (d) rotating, via the arm assembly, the bicycle from an internal side of the balcony railing to the external side.

The foregoing has outlined rather broadly the more pertinent and important features of the present disclosure so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present disclosure. It should be realized by those skilled in the art that such equivalent structures do not depart from the spirit and scope of the invention as set forth in the appended claims.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 is a perspective view of a bicycle rack according to an embodiment of the present invention;

FIG. 2 is an alternative perspective view of a bicycle rack according to an embodiment of the present invention;

FIG. 3 is an additional alternative perspective view of a bicycle rack according to an embodiment of the present invention;

FIG. 4 is a perspective view of a bicycle fastened to the bicycle rack which is clamped on a railing and positioned on an internal side of the railing according to an embodiment of the present invention;

FIG. 5 is a perspective view of the bicycle in the process of being rotated around the railing according to an embodiment of the present invention;

FIG. 6 is a perspective view of the bicycle in the process of being rotated around the railing according to an embodiment of the present invention;

FIG. 7 is a perspective view of the bicycle in the process of being rotated around the railing according to an embodiment of the present invention;

FIG. 8 is a perspective view of the bicycle rotated around the railing such that the bicycle is in a stowed position on an external side of the railing according to an embodiment of the present invention;

FIG. 9 is an alternative perspective view of the bicycle in a stowed position on the external side of the railing according to an embodiment of the present invention;

FIG. 10 is an additional alternative perspective view of the bicycle in a stowed position on the external side of the railing according to an embodiment of the present invention;

FIG. 11 is an additional alternative perspective view of the bicycle in a stowed position on the external side of the railing according to an embodiment of the present invention; and,

FIGS. 12A-B are various perspective views of alternative a bicycle rack according to an embodiment of the present invention.

### DETAILED DESCRIPTION

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein to specifically provide a rotatable bicycle rack configured to attach to a railing for improved space-saving and safety.

As used in this application, the term “a” or “an” means “at least one” or “one or more.” The term “about” or “approximately” refers to a range of values within plus or minus 10% of the specified number or location. The term “bicycle” is defined as “any bike or cycle with one or more wheels attached to a frame for transporting one or more riders via pedals, a motor, or a combination thereof.” The term “balcony” is defined as “any railing structure with or without a usable floor space positioned adjacent to an exterior portion of a building.”

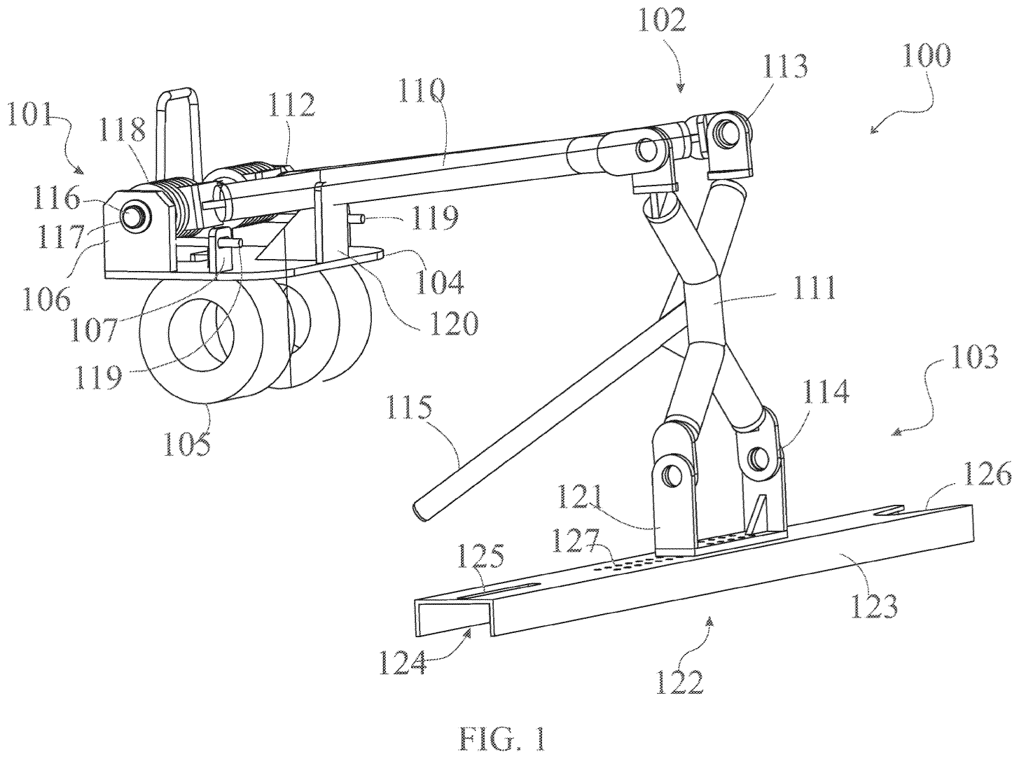

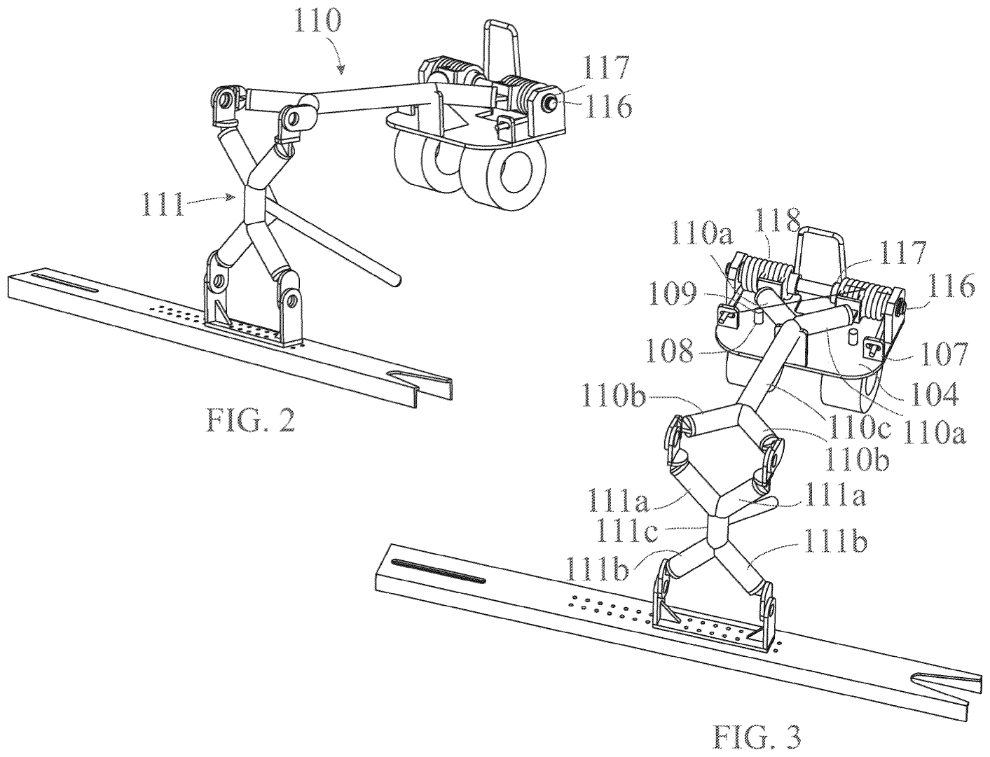

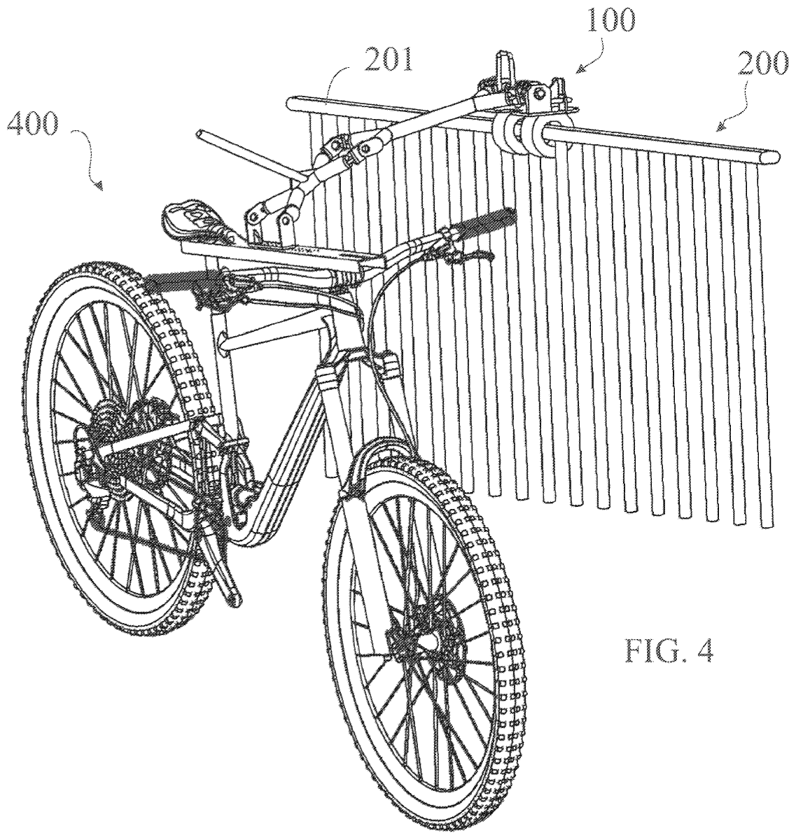

Referring now to FIGS. 1-4, various views of a bicycle rack 100 are illustrated. In one embodiment, the bicycle rack 100 comprises a clamp assembly 101, a rotatable arm assembly 102, and a mounting assembly 103. In one embodiment, the clamp assembly 101 comprises a clamp plate 104 and a clamp 105. In one embodiment, the clamp plate 104 includes a hinge bracket 106 and retaining members 107, wherein both the hinge bracket 106 and the retaining members 107 protrude perpendicularly from the plate 104. The function of these components will be discussed in greater detail below.

In some embodiments, the clamping plate 104 further comprises an opening 108 configured to receive a clamp pin 109 attached to the clamp 105, wherein the clamp pin 109 is configured to support the connection of the clamp 105 to the clamp plate 104. In alternative embodiments, the clamp 105 may be an integral component of clamp plate 104 or likewise, alternative attachment and support components may be provided. The clamp 105 is configured to secure the bicycle rack 100 and clamp assembly 101 to a railing 200, such as a balcony railing extending from a high rise building. More specifically, the clamp is configured to engage the handrail 201 of the railing 200. As handrails can be provided in different shapes and sizes, in some embodiments, the clamp 105 is configured to be adjustable in size to accommodate different handrail diameters. Likewise, although the clamp 105 illustrated is circular, the shape may vary to accommodate different handrail shapes, including but not limited to square, rectangular, beveled, oval, diamond, or combination thereof. Further, the type of clamp provided may vary as long as it is configured to fasten the bicycle rack 100 to the handrail 201 via the clamping plate 104. For instance, the clamp 105 may be a C-clamp, G-clamp, hook, coupler, hand screw clamp, spring clamp, band clamp, a custom designed clamp, or any other known clamp and coupling mechanism available. Also, although two clamps are illustrated, the number of clamps may vary depending on the clamping force necessary to secure the bicycle rack 100 and bicycle 400 safely to the handrail of the railing. In other embodiments, the bicycle rack 100 is configured to attach to any portion of the railing, such as any vertical or horizontal bar. Also, the clamp or clamps may be modified to attach to different railing material types, such as tempered glass railings.

Still referring to FIGS. 1-4, the rotatable arm assembly 102 comprises a lower arm 110, an upper arm 111, a first hinge 112, a second hinge 113, a third hinge 114, and a support member 115. The lower arm 110 is configured to rotate via the first hinge 112, wherein the first hinge 112 includes a first hinge pin 116, hinge sleeve 117, and spring 118. In one embodiment, at least a portion of the first hinge pin 116 is configured to be retained within the hinge sleeve 117, wherein the first hinge pin 116 and the hinge sleeve 117 are retained within the hinge bracket 106. The spring 118, which is preferably a torsion spring, encompasses and applies torque to the hinge sleeve 117 and the first hinge pin 116 such that rotation of the lower arm 110 and in turn the entire rotatable arm assembly 102 is assisted. In one embodiment, the ends 119 of the spring 118 are secured in the retaining members 107 to apply the torque to the first hinge 112, providing a helpful mechanical advantage when rotating an attached bicycle during use. It should be understood that the spring's characteristics, such as the number of coils, coil diameter, length, material etc. may vary depending the weight requirements of the bicycle rack. Although not illustrated, additional torsion spring may be provided on the other hinge locations in a similar fashion as described above, such as the second hinge 113 and/or the third hinge 114. Although not illustrated, the second hinge 113 and third hinge 114 may be constructed similarly to the first hinge with a hinge pin and hinge sleeve. In other embodiments, bearings or other known elements for hinges may be used.

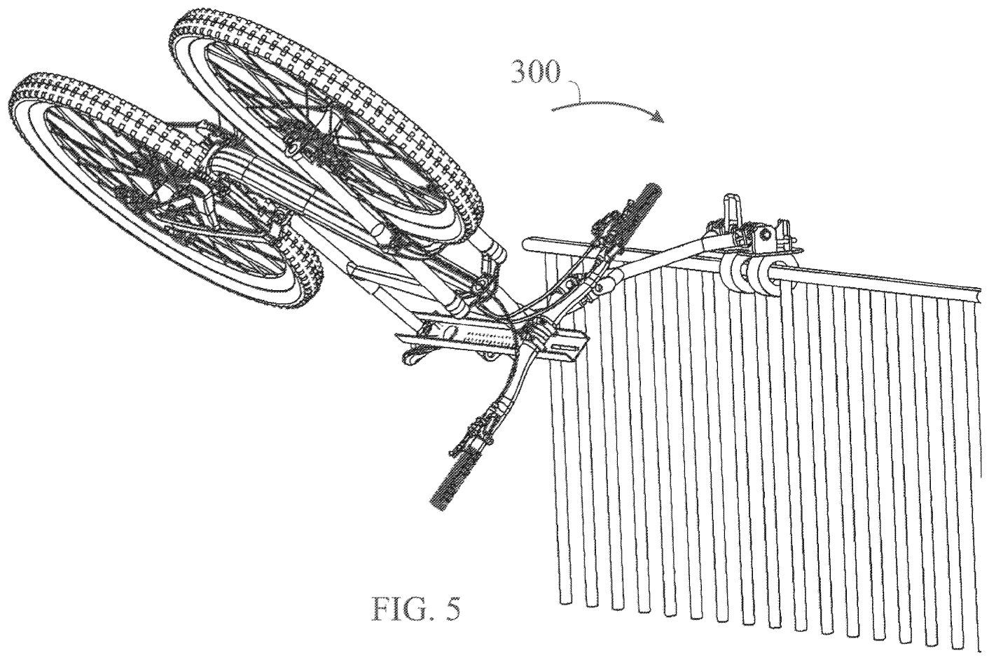

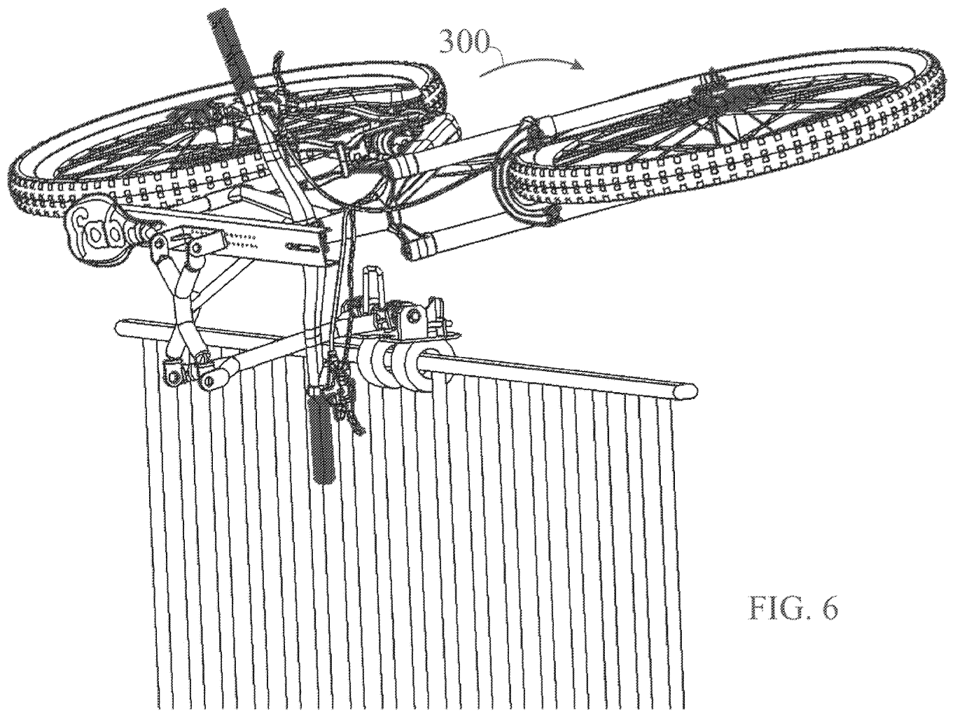

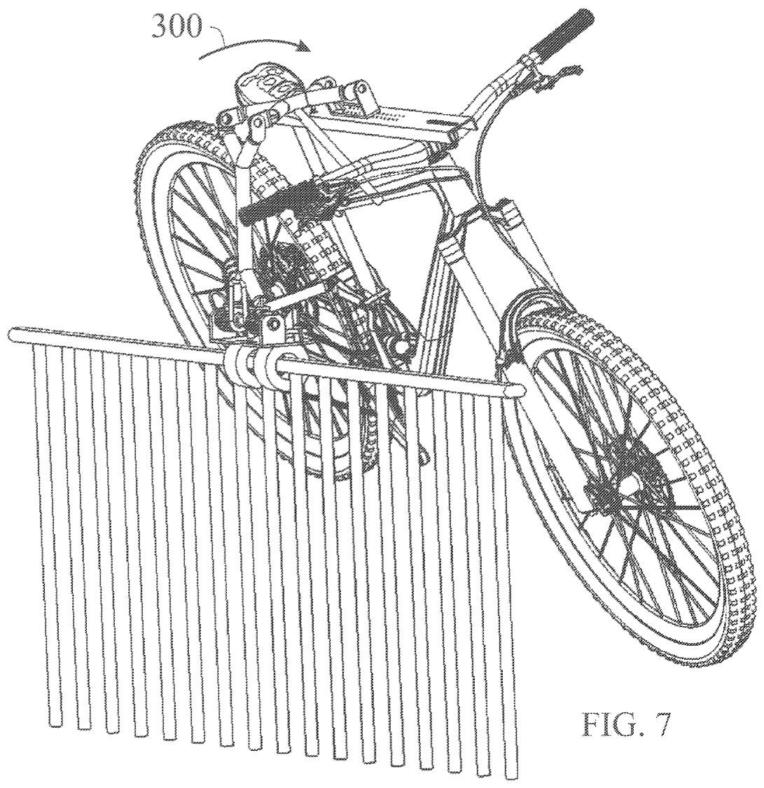

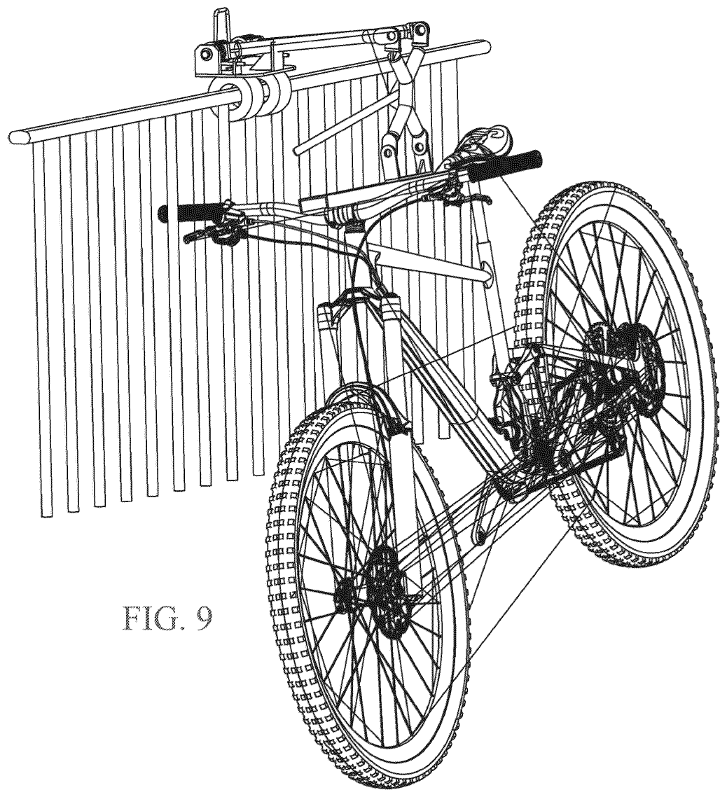

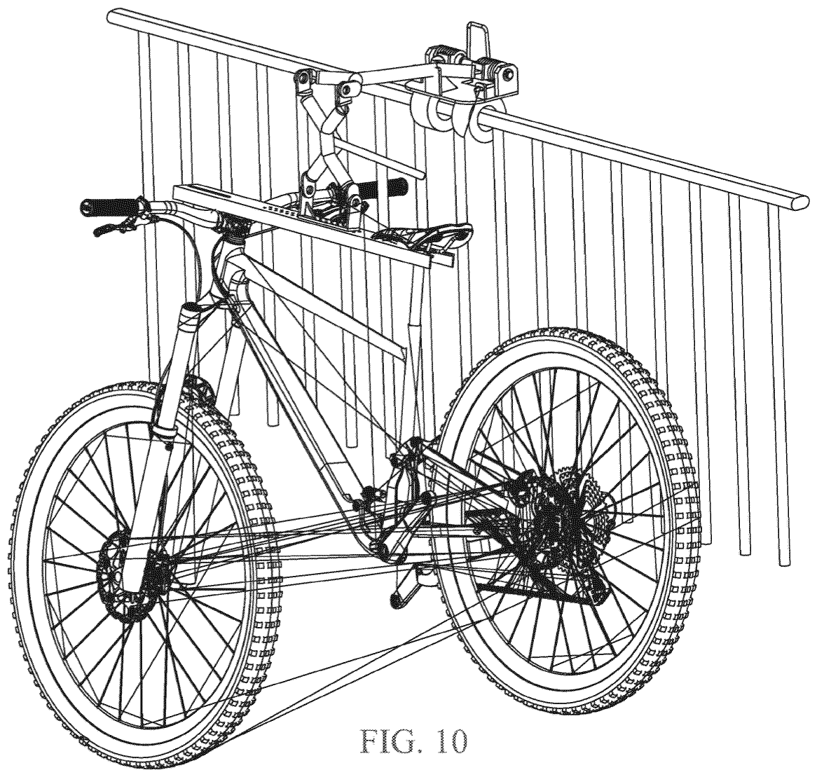

In some embodiments, a stop member 120 positioned on the clamp plate 104 is provided, wherein the stop member 120 is configured to restrict the range of motion of the lower arm's 110 rotation in a first direction 300 (best seen in FIG. 5-7). In one embodiment, the first hinge 112, and in turn the lower arm 110 is limited to 180 degrees of rotation, wherein the limit points in each direction are configured such that the lower arm is parallel or approximately parallel with a ground surface (as seen in FIGS. 4-6 and 8-11).

In one embodiment, the upper arm 111 is rotatably attached to the lower arm 110 via the second hinge 113. The upper arm 111 may rotate independently from the lower arm 110. Likewise, the upper arm is rotatably attached to the mounting assembly 103 via the third hinge 114. In some embodiments, the support member 115 is multi-purposed. First, the support member 115 may act as a support for a portion of the bicycle, such as the bicycle frame, when the bicycle is rotated from around the railing during use. Second, the support member 115 may be used as a handle during use. Third, the support member 115 may be used to restrict the rotation of the upper arm 111 in the first direction 300, such that the bicycle does not rotate into the railing when it is on the external side of the railing. In one embodiment, the support member 115 protrudes from the upper arm 111. In other embodiments, the support member 115 is an integral component with the upper arm 111.

In some embodiments, the lower arm 110 and upper arm 111 are constructed similarly including two arm pairs 110a/b and 111a/b respectively, connected by a single arm 110c and 111c respectively. In some embodiments, the single arm 110c of the lower arm 110 is longer in length than the single arm 111c of the upper arm 111. In alternative embodiments, the lower arm and upper arm consist of just a single arm. In further alternative embodiments, the lower arm and upper arm consist of two parallel arms. The shape and construction of the arms are designed to increase the stability of the invention. In this regard, the material of the arms as well as the other components may be selected for their individual properties for strength, resistance to corrosion, etc. as well known in the art. In some embodiments, the selected materials may be an alloy, such as steel, stainless steel, aluminum, or similar materials. It should be understood that this material list is not considered to be exhaustive and any material known in the art may be selected.

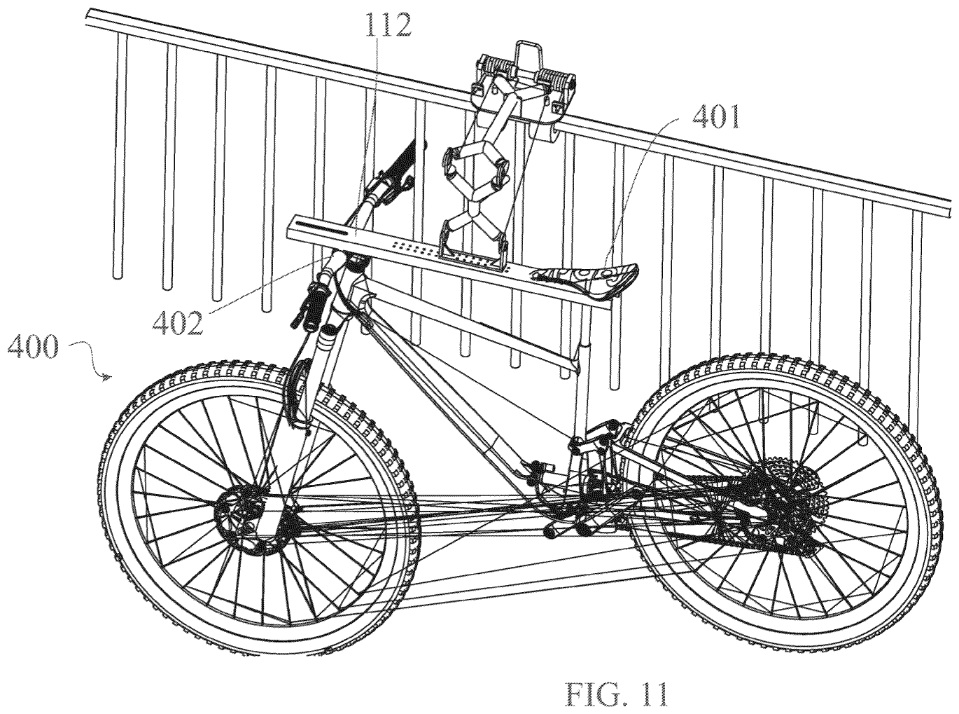

In one embodiment, the mounting assembly 103 includes a connection bracket 121 attached to a mounting member 122, wherein the mounting member 112 is configured to fasten the bicycle to the invention during use. In one embodiment, the mounting member 112 has a rectangular body 123 including a channel 124 having retaining openings 125 and 126 configured to retain one or more portions of the bicycle, such that the bicycle is secured to the mounting member 112 for use with the invention. In some embodiments, the mounting member includes a plurality of attachment locations 127 such that the connection bracket 121 may be positioned on the mounting member 112 in a number of locations along the length of the rectangular body 123. In one embodiment, best seen in FIG. 11, the one or more portions of the bicycle 400 are the bike seat 401 and handlebars 402. In alternative embodiments, the mounting member is configured to retain the bicycle's frame. In one embodiment, clamps are provided to secure the one or more portions of the bicycle 400 to the mounting member 112. In yet other embodiments, various straps, coupling members, or similar fastening devices may be used to secure the bicycle to the present invention.

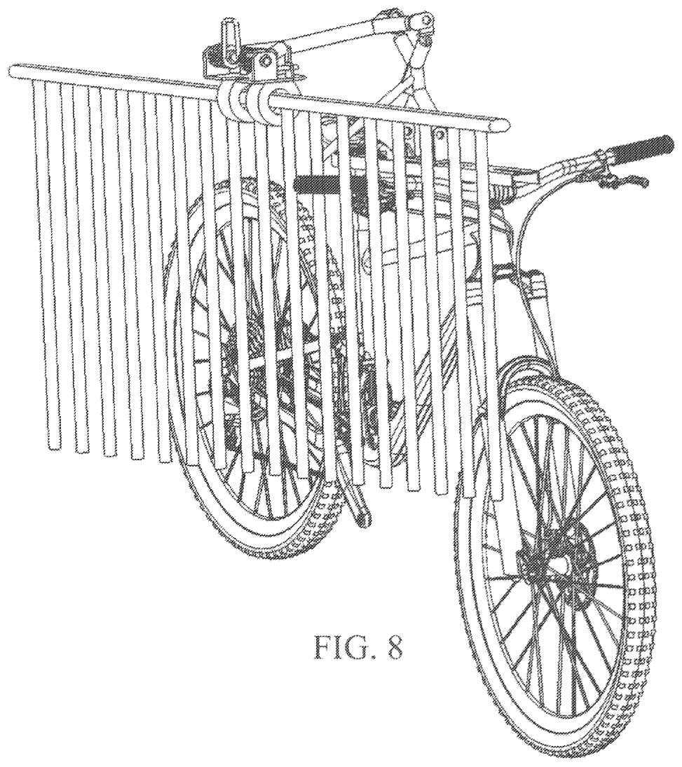

Referring now to FIGS. 4-11, the bicycle rack 100 is illustrated in use with bicycle 400. In FIG. 4 the bicycle is on the internal side of the railing 200, which is the starting position. In this position, one or more portions of the bicycle are secured to the mounting member 112 as described above. Next, a user utilizing the support member 115, the bicycle, or handles (not shown) lifts the bicycle over the railing and rotates the bicycle (seen in FIGS. 5-7) to the stowed position on an external side of the railing 200 illustrated in FIGS. 8-11. As previously discussed, the rotatable arm assembly 102 rotates and reduces the force required via the one or more torsion springs, while controlling the rotation of the bicycle by slowing down the rotation making it easier to handle the bicycle when using the rack.

In some embodiments, an integrated cover (not illustrated) may be provided to protect the bicycle 400 and bicycle rack 100 from environmental elements, such as rain, debris, snow, etc. The integrated cover may be attached to the rack itself or the handrail and include a frame support structure and a fabric structure. The shape and size of the fabric structure may vary such that the bicycle may be fully enclosed or partially enclosed, or covered in just one or more directions.

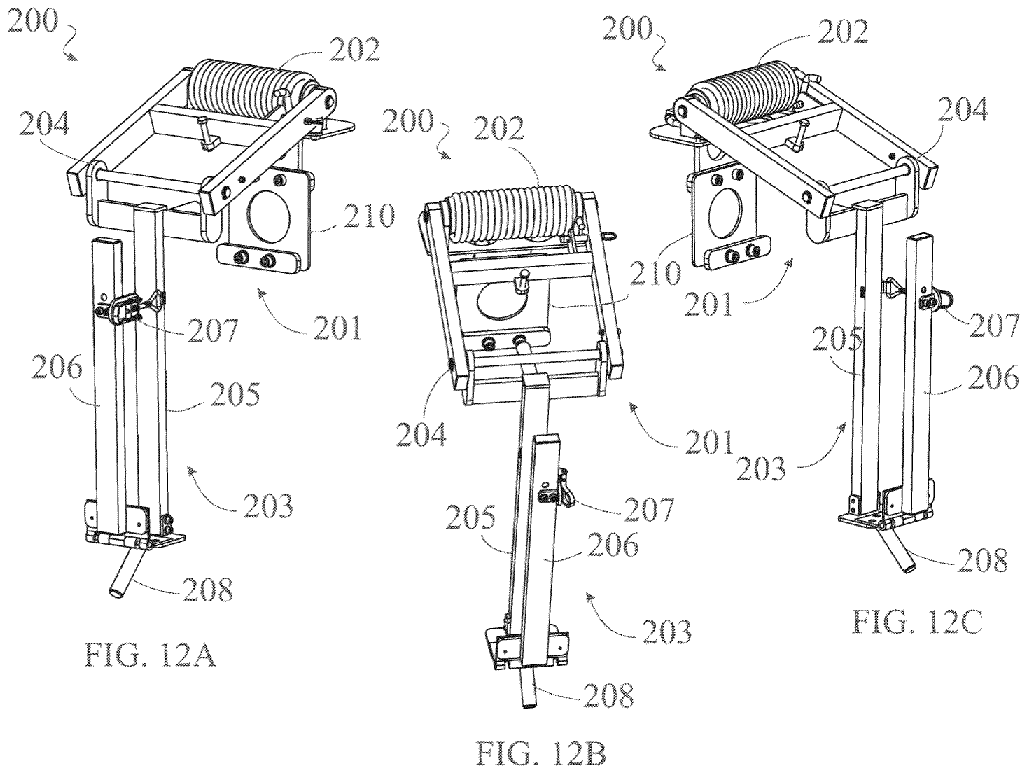

FIGS. 12A-B are various perspective views of alternative a bicycle rack 200 according to an embodiment of the present invention. Referring now to FIGS. 12A-B, the alternative bicycle rack 200 comprises a clamp assembly 201 configured to clamp on the railing via bracket 210. The clamp assembly having hinge 202 configured to allow the attached arm assembly/mounting assembly 203 to rotate at least 180 degrees such that an attached bicycle may be flipped over a railing as previously described. The hinge having a torsion spring creating a mechanical advantage as previously described. The alternative bicycle rack of the present invention functions similarly to the previously described embodiments, however it offers a simpler mechanism with one less rotational point and the mounting assembly is vertical as oppose to horizontal. In one embodiment, the arm assembly and mounting assembly 203 is combined in one aspect, i.e. the two arms 205 and 206 are configured to secure around a bicycle's chassis (not illustrated) and rotate around the clamp assembly 201 via hinge member 204. A latch 207 facilitates the locking of the bicycle's chassis within the mounting assembly. In some embodiments, a handle 208 may be provided to facilitate the user in flipping the bicycle and handling the rack.

Although the invention has been described in considerable detail in language specific to structural features, it is to be understood that the invention defined in the appended claims is not necessarily limited to the specific features described. Rather, the specific features are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention. For example, a safety cable may be provided as a failsafe in case the bicycle comes free from the rack.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) are not used to show a serial or numerical limitation but instead are used to distinguish or identify the various members of the group.

What is claimed is:

1. A bicycle rack comprising:
a clamp assembly having a clamp configured to removably fasten the clamp assembly to a railing;
an arm assembly rotatably attached to the clamp assembly;
a mounting member configured to fasten and removably attach a bicycle to the bicycle rack, wherein the mounting member is rotatably connected to the arm assembly; and,
the arm assembly enabling the attached bicycle to rotate from an internal side of the railing to an external side of the railing.

2. The bicycle rack of claim 1, wherein the arm assembly comprises a lower arm and an upper arm configured to rotate independently.

3. The bicycle rack of claim 2, wherein the lower arm is attached to the clamp assembly via a first hinge, the lower arm is attached to the upper arm via a second hinge, and the upper arm is attached to mounting member via a third hinge.

4. The bicycle rack of claim 3, wherein at least one of the first hinge, the second hinge, and the third hinge includes a torsion spring.

5. The bicycle rack of claim 3, wherein the lower arm has approximately 180 degrees of rotation via the first hinge.

6. The bicycle rack of claim 4, wherein the clamp assembly further comprises a clamp plate, wherein the clamp plate includes mounting brackets for holding the first hinge and torsion spring.

7. The bicycle rack of claim 2, wherein the lower arm and the upper arm each comprise multiple arm members for stability.

8. The bicycle rack of claim 2, a support member protruding from the upper arm configured to support at least a portion of the bicycle during rotation.

9. The bicycle rack of claim 1, wherein the clamp is configured to removably fasten to a handrail of the railing.

10. The bicycle rack of claim 9, wherein the railing is a balcony railing.

11. The bicycle rack of claim 1, wherein the mounting member comprises a rectangular body forming a channel having retaining openings configured to retain one or more portions of the bicycle.

12. A method of storing a bicycle on an external side of a balcony railing comprising steps:
(a) providing a bicycle rack comprising a clamp, an arm assembly rotatably attached to the clamp, and a mounting member;
(b) attaching, via the clamp, the bicycle rack to a handrail of the balcony railing;
(c) fastening, via the mounting member, the bicycle to the bicycle rack; and,
(d) rotating, via the arm assembly, the bicycle from an internal side of the balcony railing to the external side.
